(19) United States
(12) Patent Application Publication
(10) Pub. No.: US 2014/0074939 A1
(43) Pub. Date: Mar. 13, 2014

(54) METHOD, DEVICE AND STORAGE MEDIUM FOR ADDING FRIENDS

(71) Applicant: TENCENT TECHNOLOGY (SHENZHEN) COMPANY LIMITED, Shenzhen City, Guangdong (CN)

(72) Inventor: Banghua Zhang, Shenzhen city (CN)

(73) Assignee: TENCENT TECHNOLOGY (SHENZHEN) COMPANY LIMITED, Shenzhen City, Guangdong (CN)

(21) Appl. No.: 14/114,814

(22) PCT Filed: Nov. 5, 2012
(86) PCT No.: PCT/CN2012/084090

§ 371 Date: Oct. 30, 2013

(30) Foreign Application Priority Data
Nov. 25, 2011 (CN) 201110382469.2

(51) Int. Cl. H04L 12/58

(52) U.S. Cl. CPC H04L 51/046
USPC 709/204

(57) ABSTRACT

Disclosed are a method, a device and a storage medium for adding friends. The method comprises: storing the personal information about user terminals, which contain regional information; storing the friend-making conditions set by the user terminals, which at least contain a condition of regional information; according to the friend-making request from a user terminal, selecting a predetermined number of users and recommending them to the user terminal which sends the friend-making request, the personal information of the recommended users all satisfying the friend-making condition set by the user terminal which sends the friend-making request; and adding a friend according to the choice on the user terminal. The present invention obtains the regional information about the user terminals by means of location-based services, and according to the friend-making conditions set by the user terminals to select users satisfying the friend-making condition for the user terminal, so that the user can search and add a friend by setting regional information and the like and have a better user experience.

### FIELD OF THE DISCLOSURE

The present invention is related to the field of computer technologies, in particular to a method and device for adding friends and a storage medium.

### BACKGROUND

With the development of computer technologies and network technologies, various Instant Messaging applications and social applications have been gradually merged into people's daily lives.

Both the Instant Messaging application and the social application have a basic function of adding friends. In an existing method for adding friends, a user acquires a nickname or account number of a target user, searches for the target user according to the nickname or account number in conjunction with a searching function in the Instant Messaging application or social application, and then sends a friend adding request to the target friend.

During the development of the invention, the inventor found that the prior art is defective at least for the following problem that: to search for a friend, a user needs to know the nickname or account number of the target user, thus causing a relatively severe practical constrain because a relatively small number of target users can be found and added as friends.

### SUMMARY

In order to enable a user to look up and add a friend by setting fuzzy conditions such as regional information, a method and device for adding friends and a storage medium are provided by embodiments of the invention. Solutions of the invention are described below.

According to one aspect of the invention, an embodiment of the invention provides a method for adding friend, and the method for adding friends includes: storing personal information of each user terminal, which includes regional information; storing a friend making condition set by each user terminal, with the friend making condition including at least a regional information condition item; selecting and recommending, according to a friend adding request from the user terminal, a predetermined number of users to the user terminal sending the friend adding request, wherein, the personal information of each recommended user conforms to the friend making condition set by the user terminal sending the friend adding request; and adding a friend according to the selection made by the user terminal sending the friend adding request.

According to another aspect of the invention, an embodiment of the invention provides a device for adding friends, and the device for adding friends includes: a personal information storing module for storing personal information of each user terminal, which includes regional information; a friend making condition storing module for storing a friend making condition set by each user terminal, with the friend making condition including at least a regional information condition item; a friend recommending module for selecting and recommending, according to a friend adding request from the user terminal, a predetermined number of users to the user terminal sending the friend adding request, wherein, the personal information of each recommended user conforms to the friend making condition set by the user terminal sending the friend adding request; and a friend adding module for adding a friend according to the selection made by the user terminal sending the friend adding request.

According to another aspect of the invention, an embodiment of the invention provides a storage medium containing computer executable instructions for performing a method for adding friends, and the method for adding friends includes steps of: storing personal information of each user terminal, which includes regional information; storing a friend making condition set by each user terminal, wherein, the friend making condition includes at least a regional information condition item; selecting and recommending, according to a friend adding request from the user terminal, a predetermined number of users to the user terminal sending the friend adding request, wherein, the personal information of each recommended user conforms to the friend making condition set by the user terminal sending the friend adding request; and adding friends according to the selection made by the user terminal sending the friend adding request.

The solutions provided in embodiments of the invention bring about beneficial effects as follows.

The regional information of each user terminal is acquired through a location-based service; then, according to a friend making condition set by the user terminal, a user conforming to the friend making condition is recommended to the user terminal, so that a user is enabled to look up and add a friend by setting fuzzy conditions such as regional information. The recommended friend can be a person already known to the user, or a stranger. That is, the user is provided with better user experience.

### BRIEF DESCRIPTION OF THE FIGURES

Accompanying drawings used for the description of embodiments are briefly introduced below to more clearly illustrate the solutions in the embodiments of the invention. Apparently, drawings used for the following description illustrate only some embodiments of the invention, and other drawings can be obtained by those skilled in the art according to the accompanying drawings without any creative work.

FIG. 1 is a schematic structural diagram of an environment for implementing a method for adding friends provided in a first embodiment of the invention;

FIG. 2 is a flowchart of a method for adding friends provided in the first embodiment of the invention;

FIG. 3 is a structural block diagram of a device for adding friends provided in a second embodiment of the invention;

FIG. 4 is a structural block diagram of a regional information acquiring module provided in the second embodiment of the invention;

FIG. 5 is a structural block diagram of a friend recommending module provided in the second embodiment of the invention;

FIG. 6 is a structural block diagram of a friend adding module provided in the second embodiment of the invention.

### DETAILED DESCRIPTION

Solutions in embodiments of the invention will be described clearly and completely in conjunction with drawings accompanied with the embodiments of the invention. Apparently, the embodiments described here are only a portion of but not all of embodiments of the invention. Based on the embodiments of the invention, all other embodiments obtained by those skilled in the art without any creative work are within the protecting scope of the invention.

The embodiments of the invention will be further described in detail in conjunction with accompanying drawings.

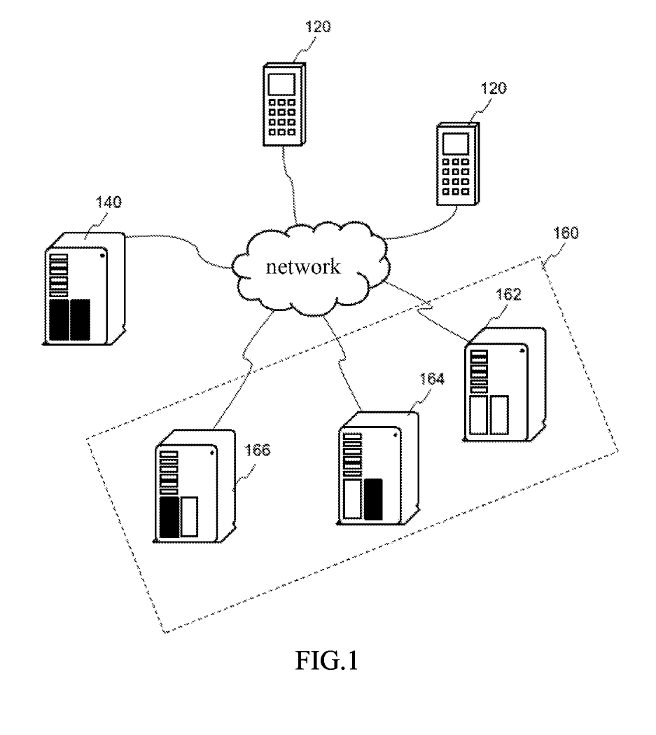

For the sake of description, a reference is made to FIG. 1 which illustrates a schematic structural diagram of an environment for implementing a method for adding friends provided in a first embodiment of the invention. The environment includes user terminals 120, a server 140, and a location-based service 160. The user terminal 120 may be a mobile terminal having a certain computing ability and running an Instant Messaging software and website or a social software and website, such as a mobile phone or a tablet computer. The server 140 may be one or more servers that provide an Instant Messaging service or the social service. Of course, the server 140 may also be a virtual cloud computing module. The location-based service 160 includes a mobile positioning system 162, a global positioning system 164 and a Geographic Information System 166. The location-based service 160 is also called as Location Based Service (LBS) in the prior art, and may acquire location information of the user terminal 120 through a radio communication network provided by the mobile carrier or the Global Positioning System (GPS) and provide a value added service of a corresponding service to a user based on the support from the Geographic Information System (GIS). Briefly, the location-based service 160 locates the user terminal 120 through the mobile positioning system 162 or the Global Positioning System 164 so as to obtain longitude and latitude information of the user terminal 120, and then queries the Geographic Information System 166 through the obtained longitude and latitude information to obtain the regional information of the user terminal 120.

### A First Embodiment

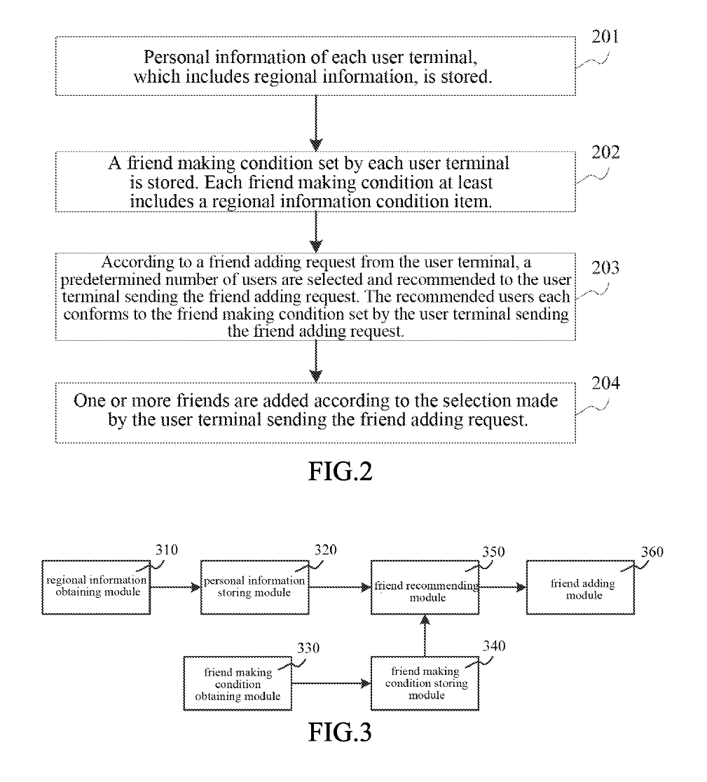

A reference is made to FIG. 2 which illustrates a flowchart of a method for adding friends based on positions provided in the first embodiment of the invention. The method for adding friends may be applied in the server 140, and includes the following steps 201-204.

At step 201, personal information of each user terminal, which includes regional information, is stored.

The server may store in advance the personal information of each user terminal, which includes the regional information. Of course, the personal information may also include other information such as a nickname, gender and a hobby. Most personal information may be collected from user inputs received by the user terminal. With respect to the collecting of the regional information, the user terminal may automatically send a self positioning request to the server when logging in the Instant Messaging application or social application, or the user terminal may send the self positioning request after receiving an instruction inputted by the user. After receiving the self positioning request from the user terminal, the server sends a first positioning request to the Global Positioning System or the mobile positioning system according to the self positioning request from the user terminal. The Global Positioning System or the mobile positioning system may locate the user terminal according to the first positioning request so as to obtain and feed back the longitude and latitude information of the user terminal to the server. The server subsequently sends a second positioning request to the Geographic Information System according to the longitude and latitude information fed back by the Global Positioning System and the mobile positioning system, and the Geographic Information System in turn looks up and obtains the regional information of the user terminal according to the longitude and latitude information, and feeds back the regional information to the server. On one hand, the server may store the regional information fed back by the Geographic Information System, and on the other hand, the server may feed back the regional information to the user terminal sending the self positioning request.

Apparently, if the user terminal automatically sends the self positioning request to the server whenever logging in the Instant Messaging application or social application, the server can always obtain timely and accurate regional information of the user terminal.

At step 202, a friend making condition set by each user terminal is stored. Each friend making condition at least includes a regional information condition item.

The user terminal may set one or more friend making conditions, each of which may include one or more specific condition items such as a gender condition item, an age condition and a regional information condition item. It should be noted that: first, each friend making condition at least includes a regional information condition item; and second, the friend making conditions are independent from each other, but a logic AND relation exists among the individual specific condition items within the same friend making condition. That is, if two friend making conditions, i.e. “female, Wuxi city in Jiangsu province” and “16-34 years old, Suzhou City in Jiangsu province”, are set by the user terminal, then the two friend making conditions are used independently in determining whether another user conforms to the friend making condition, and it is determined that the user conforms to the friend making condition if either of the two friend making conditions is satisfied. However, in determining whether another user conforms to a friend making condition, the user is determined as conforming to one of the friend making conditions only if both the gender condition item “female” and the regional information condition item “Wuxi city in Jiangsu province” in the friend making condition are met, or the user is determined as conforming to the other of the friend making conditions only if both the age condition item “16-34 years old” and the regional information condition item “Suzhou City in Jiangsu province” in the friend making condition are met. The server may receive one or more friend making conditions set by the user terminal, with each friend making condition at least including a regional information condition item. The server may store a plurality of friend making conditions respectively corresponding to different user terminals.

At step 203, according to a friend adding request from the user terminal, a predetermined number of users are selected and recommended to the user terminal sending the friend adding request. The recommended users each conform to the friend making condition set by the user terminal sending the friend adding request.

A friend adding request may be sent by the user terminal to the server. After receiving the friend adding request sent by the user terminal, the server looks up a friend making condition corresponding to the user terminal according to the friend adding request. There may be a plurality of friend making conditions corresponding to the user terminal Once finding the friend making condition(s) corresponding to the user terminal, the server selects a user whose personal information conforms to all condition items of any one of the friend making condition(s) as a recommended friend. That is, the server may find a number of friend making conditions corresponding to the user terminal, and then determines whether the personal information of another user conforms to the friend making condition. Said another user may be determined as a recommended friend once the personal information of the user conforms to any one of the friend making conditions. It should be noted again that: the description of “conforming to one of the friend making conditions” means that the personal information of another user conforms to all specific condition items in the friend making condition. Then, the server may recommend a predetermined number of recommended friends to the user terminal. Here, the predetermined number may be preset by the user terminal, or may be of a default value set by the server. For instance, the server may recommend 10 recommended friends to the user terminal each time.

In a preferred embodiment, after recommending the predetermined number of recommended friends to the user terminal, the server may further receive a subsequent friend adding request from the user terminal. After receiving the subsequent friend adding request from the user terminal, the server may recommend a further predetermined number of recommended friends to the user terminal.

At step 204, one or more friends are added according to the selection made by the user terminal sending the friend adding request.

After receiving the predetermined number of recommended friends recommended by the server, the user terminal may choose to send a subsequent friend adding request to the server, or otherwise send a friend making request to one or more recommended friends selected from the present recommended friends. The server receives and forwards the friend making request to a corresponding user terminal. After the corresponding user terminal accepts the friend making request, the server associates the users of the user terminal sending the friend adding request and the corresponding user terminal as friends.

As can be seen, in the method for adding friends provided in the present embodiment of the invention, the regional information of each user terminal is acquired through a location-based service; then, according to a friend making condition set by the user terminal, a user conforming to the friend making condition is recommended to the user terminal, so that a user is enabled to look up and add a friend by setting fuzzy conditions such as regional information. The recommended friend can be a person already known to the user, or a stranger. That is, the user is provided with better user experience.

### A Second Embodiment

A reference is made to FIG. 3 which illustrates a structural block diagram of a device for adding friends provided in the second embodiment of the invention. The device for adding friends, which may be embodied as a part of a server, includes a regional information obtaining module 310, a personal information storing module 320, a friend making condition obtaining module 330, a friend making condition storing module 340, a friend recommending module 350 and a friend adding module 360.

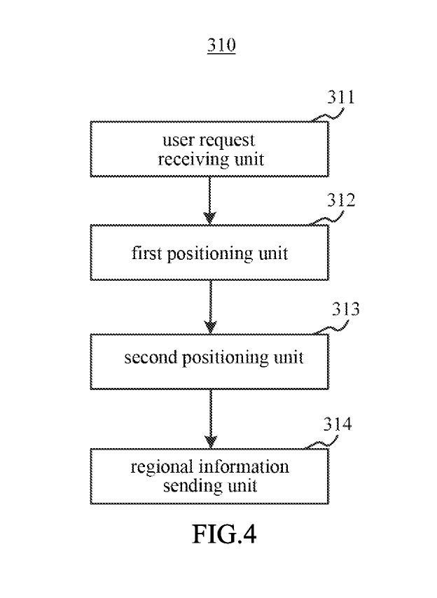

The regional information obtaining module 310 is used for obtaining the regional information of the user terminal from a location-based service according to a self positioning request from the user terminal. The regional information obtaining module 310 includes a user request receiving unit 311, a first positioning unit 312, a second positioning unit 313, and a regional information sending unit 314, as shown in FIG. 4. The user request receiving unit 311 is used for receiving the self positioning request from each user terminal. The first positioning unit 312 is used for sending a first positioning request to the Global Positioning System or a mobile positioning system according to the self positioning request. The second positioning unit 313 is used for sending a second positioning request to a Geographic Information System according to longitude and latitude information fed back by the Global Positioning System or the mobile positioning system. The regional information sending unit 314 is used for feeding back the regional information returned by the Geographic Information System to the user terminal sending the self positioning request.

The personal information storing module 320 is used for storing the regional information of each user terminal obtained by the regional information obtaining module 310. The personal information storing module 320 is also used for storing other personal information of the user terminal, such as a nickname, gender and a hobby.

The friend making condition obtaining module 330 is used for receiving one or more friend making conditions set by each user terminal, here each of the friend making conditions includes one or more condition items, one of which is a regional information condition item.

The friend making condition storing module 340 is used for storing the friend making condition set by each user terminal that is obtained by the friend making condition obtaining module 330. Each friend making condition at least includes a regional information condition item.

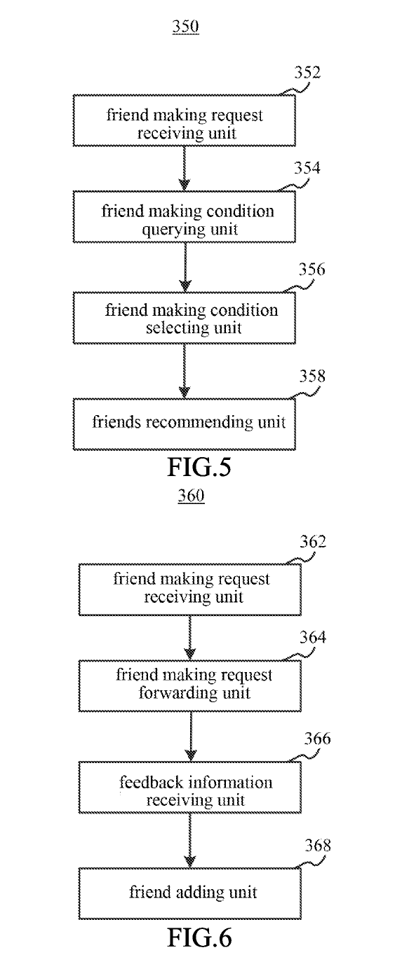

The friend recommending module 350 is used for selecting and recommending a predetermined number of users to the user terminal sending the friend adding request according to the friend adding request from the user terminal, with personal information of each recommended user conforming to the friend making condition set by the user terminal sending the friend adding request. The friend recommending module 350 includes a friend making request receiving unit 352, a friend making condition querying unit 354, a friend making condition selecting unit 356 and a friend recommending unit 358, as shown in FIG. 5. The friend making request receiving unit 352 is used for receiving the friend adding request from the user terminal. The friend making condition querying unit 354 is used for looking up all friend making conditions corresponding to the user terminal sending the friend adding request. The friend making condition selecting unit 356 is used for selecting a user whose personal information conforms to all condition items in any friend making condition as a recommended friend. The friend recommending unit 358 is used for recommending a predetermined number of recommended friends to the user terminal sending the friend adding request. Preferably, the friend making request receiving unit 352 is further used for receiving a subsequent friend adding request from the user terminal. The friend recommending unit 354 is further used for recommending a further predetermined number of recommended friends to the user terminal after the friend making request receiving unit 352 receives the subsequent friend adding request.

The friend adding module 360 is used for adding s friend according to the selection of the user terminal sending the friend adding request. The friend adding module 360 may include a friend making request receiving unit 362, a friend making request forwarding unit 364, a feedback information receiving unit 366 and a friend adding unit 368, as shown in FIG. 6. The friend making request receiving unit 362 is used for receiving a friend making request sent by the user terminal, and the friend making request includes a recommended friend selected by the user terminal. The friend making request forwarding unit 364 is used for forwarding the friend making request received by the friend making request receiving unit 362 to the recommended friend selected by the user terminal. The feedback information receiving unit 366 is used for receiving a feedback information on whether the recommended friend selected by the user terminal agrees with the friend making request. The friend adding unit 368 is used for associating the user of the user terminal and the recommended friend selected by the user terminal as friends after the feedback information receiving unit 366 receives a feedback information that the recommended friend selected by the user terminal has agreed with the friend making request.

As can be seen, the device for adding friends provided in the present embodiment of the invention acquires the regional information of each user terminal through a location-based service; then selectively recommends, according to a friend making condition set by the user terminal, a user conforming to the friend making condition to the user terminal, so that the user is enabled to look up and add a friend by setting fuzzy conditions such as regional information. The recommended friend can be a person already known to the user, or a stranger. That is, the user is provided with better user experience.

It should be noted that, when the device for adding friends provided in the embodiment of the invention is described in the second embodiment, the division of the device into the above various functional modules is illustratively described. In a practical application, the above functions may be implemented by different functional modules as desired. That is, the internal structure of the device may be partitioned into different functional modules to achieve all or some of the functions described above. Furthermore, the device for adding friends provided in the above embodiment involves a concept the same as that of the method for adding friends, therefore its detailed implementation is not described again hereinafter and a reference may be made to the method embodiment.

It would be appreciated by those skilled in the art that all or some of the steps in the above embodiments can by performed by hardware, or by a software program instructing the related hardware. The program may be stored in a computer readable storage medium, for example a Read Only Memory, a magnetic disc or a Compact Disk, etc.

The preferred embodiments of the invention have been described as above, but are not intended to limit the scope of the invention. In light of the disclosure of the invention, any modification or substitution that easily occurs to those skilled in the art should fall into the scope of the invention. Therefore, the scope of the invention is defined by the appended claims.

1.-11. (canceled)

12. A method for adding friends, comprising:
storing personal information of each user terminal, which includes regional information;
storing a friend making condition set by each user terminal, with the friend making condition including at least a regional information condition item;
selecting and recommending, according to a friend adding request from the user terminal, a predetermined number of users to the user terminal sending the friend adding request, wherein, the personal information of each recommended user conforms to the friend making condition set by the user terminal sending the friend adding request; and
adding a friend according to the selection made by the user terminal sending the friend adding request;
wherein, before storing the personal information of each user terminal, the method for adding friends further comprising:
receiving a self positioning request from each user terminal;
sending a first positioning request to a Global Positioning System or a mobile positioning system according to the self positioning request;
sending a second positioning request to a Geographic Information System according to longitude and latitude information fed back by the Global Positioning System or the mobile positioning system; and
feeding the regional information fed back by the Geographic Information System back to the user terminal sending the self positioning request.

13. The method for adding friends of claim 12, wherein, selecting and recommending, according to a friend adding request from the user terminal, a predetermined number of users to the user terminal sending the friend adding request, with the personal information of each recommended user conforming to the friend making condition set by the user terminal sending the friend adding request, comprises:
receiving the friend adding request from the user terminal;
looking up all friend making conditions corresponding to the user terminal sending the friend adding request;
selecting a user whose personal information conforms to all condition items in any of the friend making conditions as a recommended friend; and
recommending a predetermined number of recommended friends to the user terminal sending the friend adding request.

14. The method for adding friends of claim 13, after recommending the predetermined number of recommended friends to the user terminal sending the friend adding request, further comprising:
receiving a subsequent friend adding request from the user terminal; and
recommending a further predetermined number of recommended friends to the user terminal.

15. A device for adding friends, comprising:
a personal information storing module for storing personal information of each user terminal, which includes regional information;
a friend making condition storing module for storing a friend making condition set by each user terminal, with the friend making condition including at least a regional information condition item;
a friend recommending module for selecting and recommending, according to a friend adding request from the user terminal, a predetermined number of users to the user terminal sending the friend adding request, wherein, the personal information of each recommended user conforms to the friend making condition set by the user terminal sending the friend adding request; and
a friend adding module for adding a friend according to the selection made by the user terminal sending the friend adding request;
wherein, the device for adding friends further comprising a regional information obtaining module which in turn comprises:
a user request receiving unit for receiving a self positioning request from each user terminal;
a first positioning unit for sending a first positioning request to a Global Positioning System or a mobile positioning system according to the self positioning request;
a second positioning unit for sending a second positioning request to a Geographic Information System according to longitude and latitude information fed back by the Global Positioning System or the mobile positioning system; and
a regional information sending unit for feeding the regional information fed back by the Geographic Information System back to the user terminal sending the self positioning request.

16. The device for adding friends of claim 15, wherein, the friend recommending module comprises:
a friend making request receiving unit for receiving the friend adding request from the user terminal;
a friend making condition querying unit for looking up all friend making conditions corresponding to the user terminal sending the friend adding request;
a friend making condition selecting unit for selecting a user whose personal information conforms to all condition items in any of the friend making conditions as a recommended friend; and
a friend recommending unit for recommending a predetermined number of recommended friends to the user terminal sending the friend adding request.

17. The device for adding friends of claim 16, wherein,
the friend making request receiving unit is further used for receiving a subsequent friend adding request from the user terminal;
the friends-recommending unit is further used for recommending a further predetermined number of recommended friends to the user terminal.
